(19) United States
(12) Patent Application Publication
(10) Pub. No.: US 2026/0027792 A1
(43) Pub. Date: Jan. 29, 2026

(54) THERMAL CURING APPARATUS

(71) Applicant: Alcon Inc., Fribourg (CH)

(72) Inventors: Udo Schuessler, Hösbach (DE); Phil Sauerwein, Goldbach (DE); Stephan Pirl, Rüdenau (DE); Steffen Lieb, Mömlingen (DE)

(21) Appl. No.: 19/276,275

(22) Filed: Jul. 22, 2025

Related U.S. Application Data
(60) Provisional application No. 63/675,064, filed on Jul. 24, 2024.

(51) Int. Cl. B29D 11/00

(52) U.S. Cl. CPC B29D 11/00134; B29K 2905/02

(57) ABSTRACT

An apparatus for thermal curing of a lens-forming material contained in a plurality of closed contact lens molds, comprises a curing oven comprising a curing chamber for accommodating a stack of curing trays, with each curing tray of the stack arranged at a respective predetermined vertical level. The curing oven further comprises a supply channel and a baffle separating the supply channel from the curing chamber, the baffle comprising a plurality of supply holes. At a chamber inlet, the curing chamber is fluidly connected with the supply channel via the supply holes only, wherein the plurality of supply holes of the baffle are arranged along a plurality of horizontally extending rows, with one said row of the plurality of rows being arranged at an intermediate vertical level between each adjacent ones of the said predetermined vertical levels at which the curing trays of the stack are to be arranged.

### FIELD OF THE INVENTION

The present invention generally relates to the field of mass production of ophthalmic lenses, in particular contact lenses such as soft contact lenses. More specifically, it is related to an apparatus for thermally curing a lens-forming material contained in a plurality of closed lens molds to form a plurality of ophthalmic lenses, in particular contact lenses such as soft contact lenses.

### BACKGROUND OF THE INVENTION

Ophthalmic lenses, in particular contact lenses such as soft contact lenses, are typically manufactured in large quantities in automated lens manufacturing processes in automated lens manufacturing lines. By way of example, in the following it is referred to the manufacture of contact lenses such as soft contact lenses.

In one type of a contact lens manufacturing line, single-use plastic lens molds comprising a female mold half and a male mold half may be used. Such single-use plastic lens molds are typically made from a thermoplastic material, in particular from a polyolefine such as polypropylene, which allows for a reliable and cost-efficient production of the lens molds in large quantities by injection-molding.

For the manufacture of a contact lens using single-use plastic lens molds formed by injection-molding, a lens-forming material is typically introduced into the female mold half which is then mated with the male mold half to close the lens mold such that the lens-forming material is enclosed in a cavity of the closed lens mold. To form the contact lens, the lens-forming material contained in the cavity is thermally cured by exposing the closed lens mold to heat of a predetermined temperature in a curing oven.

To achieve a high production yield, a large number of contact lenses are concurrently formed during the curing step. For that reason, a large number of closed lens molds may be arranged on a plurality of curing trays which are arranged one above the other to form a stack. This stack is then introduced into a curing chamber of the oven

Curing of the lens-forming material may be performed at different predetermined curing temperature levels and for predetermined durations at the respective predetermined curing temperature level, depending on the lens-forming material. By way of example, the lens-forming material may be cured at three different curing temperature levels, and for a duration from thirty to sixty minutes at each of the three curing temperature levels.

During each heating-up phase to the next curing temperature level (in the case of three different temperature levels from the basic temperature level up to the first curing temperature level, from the first curing temperature level to the second curing temperature level, and from the second curing temperature level to the third curing temperature level), without any specific measures the temperature distribution in the curing chamber is very inhomogeneous, and it may take considerable time (for example up to twenty minutes) until a homogenous temperature distribution may actually be reached in the curing chamber at the respective curing temperature level. As a consequence, the lens-forming material is cured at different curing temperatures, depending on the position of the respective lens mold on the respective curing tray, and depending on the position of the respective curing tray in the stack. This may result in differences of certain parameters of the contact lenses (for example, it may lead to deviations from the set diopter).

The heat of the respective predetermined curing temperature level may be provided by a gas heated to the respective curing predetermined temperature level, and this gas is circulated through the curing oven such that it flows above and below each curing tray of the stack arranged in the curing chamber. Depending on the flow rate of the heated gas, molds having a tab of a certain size may get swirled up by the gas flow and may be displaced. Obviously, such displacement of molds is unwanted as displaced molds cannot be automatically handled during the subsequent manufacturing steps (e.g. automated unloading of the molds from the trays).

Another disadvantage is that the bulk material the curing trays are made of in order to be sufficiently stable (e.g. aluminum) may exhibit an unwanted large heat capacity which may also contribute to the inhomogeneous temperature distribution in the curing chamber.

It is therefore an object of the invention to overcome the aforementioned disadvantages and to provide an apparatus for thermally curing a lens-forming material contained in a plurality of closed lens molds in the curing chamber of which there is a temperature distribution with a substantially improved homogeneity.

### SUMMARY OF THE INVENTION

In accordance with the present invention, an apparatus as specified by the features of the independent claim is suggested for thermally curing a lens-forming material contained in a plurality of closed lens molds to form a plurality of ophthalmic lenses, in particular contact lenses such as soft contact lenses. Advantageous aspects of the apparatus according to the invention are the subject of the dependent claims.

As used in the specification including the appended claims, the singular forms “a”, “an”, and “the” include the plural, unless the context explicitly dictates otherwise. When using the term “about” with reference to a particular numerical value or a range of values, this is to be understood in the sense that the particular numerical value referred to in connection with the term “about” is included and explicitly disclosed, unless the context clearly dictates otherwise. For example, if a range of “about” numerical value A to “about” numerical value B is disclosed, this is to be understood to include and explicitly disclose a range of numerical value A to numerical value B. Also, whenever features are combined with the term “or”, the term “or” is to be understood to also include “and” unless it is evident from the specification that the term “or” must be understood as being exclusive.

In accordance with the invention, an apparatus for thermally curing a lens-forming material contained in a plurality of closed lens molds to form a plurality of ophthalmic lenses, in particular contact lenses such as soft contact lenses, is suggested.

The apparatus comprises:
a curing oven comprising
   a curing chamber having a chamber inlet and a chamber outlet arranged opposite to the chamber inlet, for accommodating a stack of curing trays for carrying the plurality of closed lens molds with the lens-forming material contained therein at a predetermined position between the chamber inlet and the chamber outlet, with each curing tray of the stack arranged at a respective predetermined vertical level;
   a supply channel for supplying gas heated to a predetermined curing temperature to the curing chamber; and
a baffle arranged at the chamber inlet and separating the supply channel from the curing chamber, the baffle comprising a plurality of supply holes,
wherein at the chamber inlet the curing chamber is fluidly connected with the supply channel via the supply holes only.

The plurality of supply holes of the baffle are arranged along a plurality of horizontally extending rows, with one said row of the plurality of rows being arranged at an intermediate vertical level between each adjacent ones of the said predetermined vertical levels at which the curing trays of the stack are to be arranged.

One said row of the plurality of rows is arranged at a vertical level above the predetermined vertical level of the uppermost curing tray of the stack and one said row of the plurality of rows is arranged at a vertical level below the predetermined vertical level of the lowermost curing tray of the stack.

According to one aspect of the apparatus according to the invention, the supply holes of the baffle are arranged along each individual row of the plurality of horizontally extending rows in a zigzag pattern.

According to another aspect of the apparatus according to the invention, a total cross-sectional area of all supply holes of the baffle is equal to or larger than a minimum cross-sectional area of the supply channel.

According to yet another aspect of the apparatus according to the invention, the baffle comprises a flat metal sheet, in particular a flat aluminum sheet, comprising the plurality of supply holes.

According to a further aspect of the apparatus according to the invention, each of the supply holes of the baffle has a circular cross-section having a diameter in the range of 6 millimeters to 10 millimeters, in particular in the range of 7 millimeters to 9 millimeters, especially 8 millimeters.

According to another aspect of the apparatus according to the invention, the curing oven further comprises
a heater for heating a gas to the predetermined curing temperature, the heater being arranged in a heating channel, the heating channel comprising
   a channel inlet which is fluidly connected to the chamber outlet of the curing chamber;
   a channel outlet which is fluidly connected to the supply channel; and
a fan for generating a circulating gas flow inside the curing oven.

According to yet another aspect of the apparatus according to the invention, the apparatus further comprises a said stack of curing trays for carrying the plurality of closed lens molds with the lens-forming material contained therein.

According to a further aspect of the apparatus according to the invention, each curing tray of the stack comprises at least one support plate, the at least one support plate comprising an upper support surface with a plurality of mold seats arranged thereon in a rectangular pattern along seat rows and seat columns, each mold seat configured to receive one of the closed lens molds.

The seat rows extend along a longitudinal direction of the at least one support plate, and the seat columns extend along a transverse direction of the at least one support plate perpendicular to the longitudinal direction.

Each curing tray of the stack comprises a first plurality of shielding tabs arranged at a first longitudinal end of the respective curing tray, with each of the shielding tabs of the first plurality of shielding tabs having a predetermined height above the upper support surface of the support plate and having a predetermined tab width in the transverse direction of the support plate. Each shielding tab of the first plurality of shielding tabs at least partially overlaps with the mold seats of one said seat row in the transverse direction of the support plate to shield the closed lens molds arranged at the mold seats of the respective seat row from being exposed to a flow of heated gas supplied to the curing chamber of the curing oven through the supply holes of the baffle, with adjacently arranged shielding tabs being separated from one another by a gap of a predetermined gap width.

According to another aspect of the apparatus according to the invention, each of the closed lens molds comprises a base mold half and a top mold half arranged on the base mold half. The base mold half comprises a radially protruding base mold half tab and the top mold half comprises a radially protruding top mold half tab, with the top mold half tab and the base mold half tab including a rotational angle between them which is equal to or less than 90 degrees. Each mold seat of the plurality of mold seats arranged on the upper support surface of the support plate comprises a seat center as well as orientation-locking elements for locking the respective base mold half tab therebetween such that the base mold half tabs of all base mold halves extend in a same predetermined direction that corresponds to the transverse direction of the at least one support plate.

Each of the shielding tabs of the first plurality of shielding tabs is arranged to extend at least from the orientation locking elements to the seat centers of the mold seats of the respective seat row.

According to yet another aspect of the apparatus according to the invention, each curing tray of the stack comprises a second plurality of shielding tabs arranged at a second longitudinal end of the respective curing tray opposite to the first longitudinal end.

The number of the second plurality of shielding tabs corresponds to the number of the first plurality of shielding tabs,
and each of the shielding tabs of the second plurality of shielding tabs is aligned with a respective shielding tab of the first plurality of shielding tabs.

According to a further aspect of the apparatus according to the invention, each curing tray of the stack further comprises
a mounting frame; and
a tray plate mounted to the mounting frame.

The at least one support plate is mounted to the tray plate.

According to another aspect of the apparatus according to the invention, the plurality of shielding tabs are integrally formed with the respective tray plate and extend upwardly therefrom.

According to yet another aspect of the apparatus according to the invention, the mounting frame is made of aluminum and has a thickness of less than 9 millimeters, in particular less than 8 millimeters, and especially 7 millimeters.

According to a further aspect of the apparatus according to the invention, the tray plate is made of aluminum and has a thickness of less than 1.5 millimeters, in particular less than 1.3 millimeters, especially 1 millimeter.

According to another aspect of the apparatus according to the invention, the at least one support plate comprises a plurality of support plate through-openings, and the tray plate comprises a plurality of tray plate through-openings which are aligned with the plurality of support plate through openings.

The support plate comprises a latch extending downwardly from an edge of at least one of the support plate through-openings to engage with an edge of at least one of the tray plate through-openings to attach the at least one support plate to the tray plate. The edge of the at least one of the tray plate through-openings to be engaged by a latch comprises a crimped edge.

The apparatus according to the invention offers a number of advantages. The arrangement of the supply holes of the baffle along the horizontally extending rows allows for a uniform gas flow of the heated gas across each curing tray of the stack. As one horizontally extending row of supply holes is arranged above each of the curing trays and another horizontally extending row of supply holes is arranged below each of the curing trays to provide a gas flow of the heated gas above and below each of the curing trays, heat of the predetermined curing temperature is concurrently provided from the top and from the bottom to the closed lens molds arranged on each of the curing trays.

The fluid connection of the supply channel with the curing chamber only via the supply holes of the baffle makes sure the heated gas supplied through the supply channel enters the curing chamber only at the predetermined locations and at the vertical levels where the supply holes are arranged, so that in the heating chamber the heated gas flows through the gap formed between adjacently arranged curing trays of the stack.

It is thus avoided that heated gas from the supply channel enters the curing chamber through any channels or openings other than the supply holes, as such unwanted (parasitic) gas flow entering the curing chamber through any channels or openings other than the supply holes of the baffle may contribute to an inhomogeneous temperature distribution within the curing chamber. Thus, the provision of the supply holes in the baffle and the gas supply from the supply channel to the curing chamber exclusively through the supply holes of the baffle very substantially increases the homogeneity of the temperature distribution within the curing chamber.

As has been mentioned, curing of the lens-forming material may be performed at only one curing temperature level or may be performed at a plurality of different curing temperature levels (e.g. at three different curing temperature levels), and for predetermined durations at the respective curing temperature level. By way of example, the curing temperatures may comprise curing temperature levels in the range of 50° C. to 100° C.

Due to the supply of the heated gas through the specifically arranged supply holes in the baffle (see discussion above), the temperature distribution within the curing chamber is very homogeneous. This holds for the heating-up phases, too. Due to this very substantial increase of the homogeneity of the temperature distribution within the curing chamber, the risk that lens-forming material is cured at different curing temperatures depending on the position of the lens mold on the respective curing tray and further depending on the position of the curing tray in the stack is greatly reduced, so that variations of lens parameters of the cured ophthalmic lenses may be avoided.

The curing oven may comprise a heat-insulating oven wall and an access opening that may be opened or closed by a heat-insulating door to allow a stack of curing trays carrying a large number of closed lens molds containing a lens-forming material to be loaded into the curing chamber of the curing oven through the access opening while the door is open. Loading of the stack of curing trays into the curing chamber may be performed, for example, with the aid of a handling robot. Thereafter, the door is closed, thus closing the curing chamber with the stack of curing trays arranged therein in a heat-insulated manner whereupon thermal curing of the lens-forming material may be performed to form cured ophthalmic lenses in the closed lens molds. Once curing of the lens-forming material is completed, the temperature in the curing chamber may be cooled down again and the door is subsequently opened, whereupon the handling robot may remove the stack from the curing chamber and transport the stack to the next station at which the individual trays of the stack may be unstacked, so that the lens molds containing the closed molds may subsequently be demolded and the cured ophthalmic lenses removed (delensed) for being further processed (e.g. extracted, hydrated, coated, etc.).

The arrangement of the supply holes of the baffle in a zigzag pattern along each row is advantageous in that it allows for a gas flow within the curing chamber which is even more homogeneous at the respective vertical level of the respective row. The alternating arrangement of the supply holes in the zigzag pattern along each row further allows to provide a cross-sectional area and shape of the individual supply holes which are advantageous with regard to the generation of unwanted turbulences in the gas flow at the respective vertical level. In addition, the zigzag pattern allows to have a total cross-sectional area of all supply holes of a row that allows the supply holes of a row to be non-overlappingly arranged along the respective row while at the same time allowing for a gas flow sufficient to provide the desired amount of heat in the curing chamber.

For instance, the supply holes may have a circular cross-section having a diameter in the range of 6 millimeters to 10 millimeters, in particular in the range of 7 millimeters to 9 millimeters, especially 8 millimeters.

The total cross-sectional area of all supply holes of the baffle (i.e. the sum of the total cross-sectional areas of the supply holes of all rows) is larger than the (smallest) cross-sectional area of the supply channel. By this measure, it is avoided that heated gas may accumulate at the baffle, which may negatively affect the gas flow into the curing chamber.

The baffle may comprise a flat metal sheet having the plurality of supply holes arranged along the plurality of horizontally extending rows at the predetermined vertical levels. The flat metal sheet may be arranged vertically, with the supply holes extending horizontally through the flat metal sheet. The flat metal sheet has a low heat capacity and may be made, for instance, from aluminum.

The heater may be configured to heat the circulating gas in the curing oven to the respective predetermined curing temperature. The heater may be coupled to a temperature controller for controlling its temperature. The heating channel, the supply channel and the curing chamber together may form a closed-loop flow path along which the gas circulates in the curing oven. A fan may be arranged in the heating channel and may generate a gas flow along the predetermined closed-loop flow path such that the gas flows from the heating channel to the supply channel, from the supply channel into the curing chamber through the supply holes of the baffle arranged at the chamber inlet, and from the chamber outlet back to the heating channel. Such closed-loop flow path is very efficient with respect to the consumption of energy required to heat the gas to the predetermined curing temperature.

The curing trays may have a rectangular shape, and the at least one mold support plate of the curing trays may comprise a plurality of rectangular support plates arranged thereon in a rectangular pattern.

Each of these mold support plates may comprise, in addition to the orientation-locking elements for locking the base mold half at a predetermined orientation, one or more position-locking elements to determine a predetermined (translational) position of the closed lens mold on the upper support surface of the (mold) support plate at the respective mold seat. For instance, the one or more position-locking elements may comprise a plurality of pins extending upwardly from the upper support surface and arranged to surround the predetermined position of the closed lens mold at the respective mold seat. The (mold) support plate may further comprise a through-opening arranged at each of the mold seats to allow exposure of the base mold half (from below) to the heated gas of the predetermined curing temperature, such that the lens-forming material contained in the closed lens mold is uniformly heated from all sides to cause uniform heating and thus uniform curing of the lens-forming material contained in the closed lens mold.

The arrangement of the mold seats in a rectangular pattern along seat rows and seat columns is advantageous to avoid the generation of turbulences in the gas flow across the curing trays while the closed lens molds are arranged at the mold seats on the (mold) support plates. In addition, an arrangement of the mold seats (and thus of the closed lens molds) along seat rows and seat columns allows for shielding the closed lens molds from being directly exposed to the gas flow with the aid of shielding tabs associated to the respective seat row. The at least partially overlapping arrangement of the shielding tabs with the mold seats arranged along the seat rows may be such that they prevent the closed lens molds arranged at the mold seats from being lifted off of the mold seats and from being displaced (blown away) by the direct exposure to the gas flow.

Accordingly, the predetermined height and width of the shielding tabs are preferably chosen such as to cover any protruding portions of the lens molds arranged at the mold seats along the seat rows. The predetermined gap width between adjacently arranged tabs is chosen large enough to admit sufficient gas to flow through the gaps to make sure a sufficient amount of gas may flow between the seat rows to provide the desired heat required for thermally curing the lens-forming material contained in the closed lens molds.

The seat center of a mold seat is that portion of the respective mold seat with which a center of the cavity of the closed lens mold for forming the ophthalmic lens is vertically aligned when the closed lens mold is arranged at the mold seat.

The closed lens mold may comprise a mold body formed by respective mold half body portions of the top mold half and the base mold half, from which a top mold half tab and a base mold half tab may protrude radially (outwardly). The mold body comprises the cavity containing the lens-forming material to be cured and may, for instance, have a cylindrical shape. In that case, the closed lens mold may be arranged at the mold seat with the cylinder axis of the cylindrically shaped mold body running vertically through the seat center. The base mold half of the closed lens mold may be a female mold half comprising a concave mold surface for forming the front curve of the ophthalmic lens, and the top mold half of the closed lens mold may be a male mold half comprising a convex molding surface for forming the base curve of the ophthalmic lens. In case the ophthalmic lens to be formed is toric, the orientation of the (toric) axes (major axis and minor axis) may be determined by the orientation of the top mold half relative to the base mold half, which may correspond to the rotational angle included between the top mold half tab and the base mold half tab.

The orientation-locking elements of the mold support plates may be arranged such that they engage the base mold half tab. For instance, the orientation-locking elements may comprise a pair of pins protruding vertically from the upper support surface of the (mold) support plate and may be spaced apart to match the width of the base mold half tab so as to be able to accommodate and engage the (radially outwardly protruding) base mold half tab.

When the base mold halves are arranged such that their base mold half tabs all extend in the transverse direction of the (mold) support plate, the possible arrangements of the top mold half tabs may be confined to a zone that extends from the seat centers of the mold seats in the transverse direction of the (mold) support plate. As the possible angle between the base mold half tabs and the top mold half tabs is between 90° and −90° (maximum possible toric angles), this zone into which the top mold half tabs protrude has a zone width that corresponds to the radial extension of the top mold half tab from the center of the closed lens mold.

By arranging the shielding tabs of the first plurality of shielding tabs to extend in the said transverse direction at least from the orientation locking elements for locking the orientation of the base mold half tabs to the seat centers of the mold seats of the respective seat row, the base mold half tabs as well as the top mold half tabs of the closed lens molds are either completely or nearly completely shielded from being directly exposed to the gas flow entering the curing chamber through the supply holes of the baffle.

A second plurality of shielding tabs may be advantageous in that it allows the arrangement of the curing trays with either of the two longitudinal ends facing the curing chamber inlet or the chamber outlet. This may be advantageous, for example, in case the individual curing oven is part of a curing module that may comprise of plurality of curing ovens arranged at both sides (i.e. left or right) of a track along which the handling robot may transport the stack of curing trays with the closed lens molds arranged thereon to the respective oven. The robot may then turn either to the left or to the right. In one case the first plurality of shielding tabs shields the closed lens molds from being directly exposed to the gas flow, in the other case the second plurality of shielding tabs shields the closed lens molds from being directly exposed to the gas flow (depending on which side of the track the oven is arranged in which the stack of curing trays is to be loaded).

One or more of the afore-described support plates may be mounted to a tray plate of the curing tray. The one or more support plates may be fastened to the tray plate. The support plate may comprise a plurality of seat through-openings, each of which is arranged at a respective mold seat of the support plate such that the respective seat through-opening is arranged underneath the closed lens mold arranged at the respective mold seat. The tray plate may comprise a plurality of tray plate seat through-openings vertically aligned with the plurality of seat through-openings of the one or more support plates.

The support plates may be made of plastic, in particular in particular an injection-moldable plastic, for example polybutylene terephthalate reinforced by glass fibers (e.g. by 10% glass fibers), and the tray plate may be made of metal, in particular aluminum. The metal tray plate provides for stability whereas the plastic support plate thermally separates the closed lens molds arranged thereon from the metal tray plate to avoid an unwanted heat transfer through direct contact of the base part of the closed lens with the metal tray plate, as such direct heat transfer may lead to a non-uniform heating of the base mold halves of the closed lens molds.

The afore-mentioned plurality of shielding tabs may be integrally formed with the respective tray plate (which is typically made of aluminum) which provides for a high degree of stability of the shielding tabs.

Aluminum as a material for the mounting frame of the curing tray is advantageous in that it provides for a high stability of the mounting frame on one hand, and in that it has a low heat capacity on the other hand. Moreover, the low weight of aluminum is advantageous for handing the stack of curing trays. A thickness of the mounting frame of less than 9 millimeters, in particular less than 8 millimeters, and especially 7 millimeters is advantageous with respect to both low heat capacity as well as sufficient stability.

Aluminum is further advantageous for the material of the tray plate for the same reasons. A thickness of the tray plate of less than 1.5 millimeters, in particular less than 1.3 millimeters, especially 1 millimeter is advantageous in that the tray plate exhibits a low heat capacity and at the same time sufficient stability. The tray plate may have a crimped edge at some of the tray plate through-openings to allow the use of (mold) support plates that are also suitable for tray plates having a larger thickness. To engage the crimped edge, the (mold) support plates may be provided with latches for engaging the crimped edge to attach the support plates to the tray plate.

### BRIEF DESCRIPTION OF THE DRAWINGS

Further advantageous aspects of the invention become apparent from the following description of embodiments of the invention with the aid of the (schematic) drawings, in which:

FIG. 1 shows a cross-sectional front view of an embodiment of the apparatus according to the invention;

FIG. 2 shows a cross-sectional perspective view of the embodiment of the apparatus according to the invention;

FIG. 3 shows an enlarged view of detail III of FIGS. 2;

FIG. 4 shows a perspective view of an embodiment of a curing tray of the stack of curing trays of the embodiment of the apparatus according to the invention;

FIG. 5 shows an exploded perspective view of the components of the curing tray shown in FIG. 4;

FIG. 6 shows a perspective view of a portion of the curing tray shown in FIG. 4;

FIG. 7 shows a perspective bottom view of a portion of the curing tray shown in FIG. 4;

FIG. 8 shows another perspective view of a portion of the curing tray shown in FIG. 4, with some closed lens molds arranged at the mold seats of the support plate of the curing tray;

FIG. 9 shows a side view of a portion of the curing tray; and

FIG. 10 shows an enlarged view of detail X of FIG. 9.

### DETAILED DESCRIPTION OF EMBODIMENTS

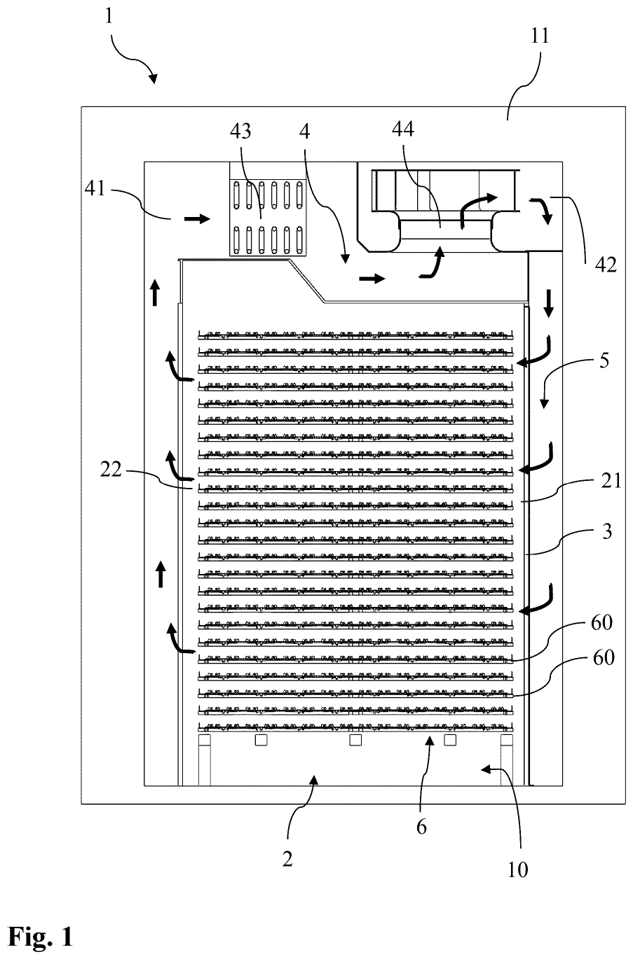

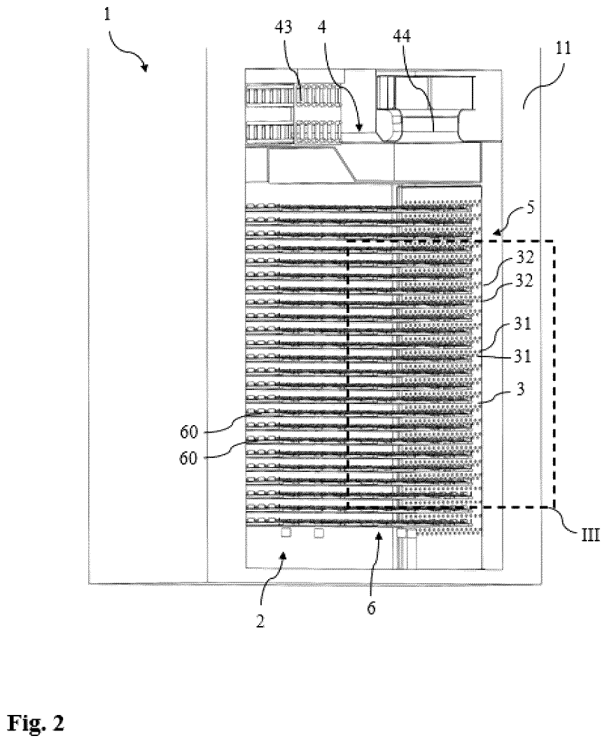

FIG. 1 shows a cross-sectional front view of an embodiment of the apparatus according to the invention. The apparatus comprises a curing oven 1 with a stack 6 of curing trays 60 arranged in a curing chamber 2 thereof. FIG. 2 shows a perspective cross-sectional view of the same embodiment of the apparatus.

The curing oven 1 comprises a heat-insulated oven wall 11 surrounding an interior space of the curing oven 1. The curing oven 1 further comprises an access opening 10 through which the stack 6 of curing trays 60 can be loaded into the curing chamber 2 of the curing oven 1 and unloaded from the curing chamber 2 of the curing oven 1. The access opening 10 can be opened and closed in a heat-insulating manner by a door of the oven (not shown in the drawings).

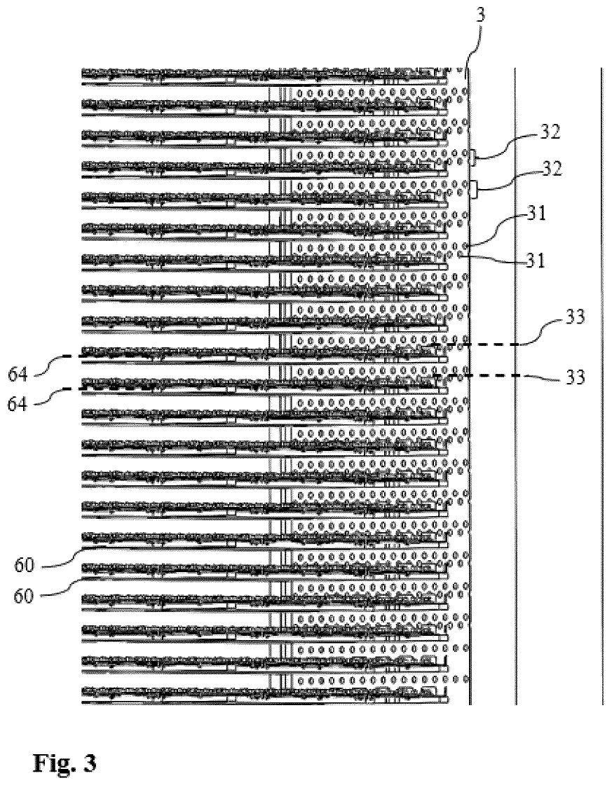

The curing chamber 2—in operation—accommodates the stack 6 of curing trays 60, as shown in FIG. 1 and FIG. 2. The curing chamber 2 comprises a chamber inlet 21 and a chamber outlet 22 arranged opposite to the chamber inlet 21. The stack 6 is arranged in the curing chamber 2 at a predetermined position between the chamber inlet 21 and the chamber outlet 22, and each of the curing trays 60 of the stack 6 is arranged at a predetermined vertical level 64 (see FIG. 3) in the curing chamber 2.

The curing oven 1 further comprises a supply channel 5 for supplying heated gas of a predetermined curing temperature to the curing chamber 2. The curing chamber 2 and the supply channel 5 are separated by a baffle 3 comprising a plurality of supply holes 31. In the embodiment shown, the baffle 3 is a flat aluminum sheet which extends along the vertical direction at the chamber inlet 21, and the supply holes 31 are embodied as horizontal through-holes through the aluminum sheet. The baffle 3 fluidically separates the chamber inlet 21 from the supply channel 5 except for the supply holes 31, such that the curing chamber 2 is fluidically connected to the supply channel 5 only via the supply holes 31 of the baffle 3.

Each of the supply holes 31 has a circular cross-section with a diameter that is generally in the range of 6 millimeters to 10 millimeters, more particularly in the range of 7 millimeters to 9 millimeters, and may for example be 8 millimeters. The sum of the cross-sectional areas of the circular cross-sections of all supply holes 31 (i.e. the total cross-sectional area of the supply holes 31 of the baffle 3) is equal or larger than the smallest cross-sectional area of the supply channel 5.

As can be seen best in FIG. 3 showing an enlarged view of the detail III of FIG. 2, the supply holes 31 are arranged along a plurality of horizontally extending rows 32. Along each individual horizontally extending row 32, the supply holes 31 are arranged in a zigzag pattern. An individual horizontally extending row 32 of supply holes 31 is arranged at an intermediate vertical level 33 between each two adjacently arranged vertical levels 64 at which the curing trays 60 are arranged in the curing chamber 2. In addition, one individual horizontally extending row 32 is arranged at a vertical level 33 above the vertical level 64 at the which the uppermost curing tray 60 of the stack 6 is arranged, and another one individual horizontally extending row 32 is arranged at a vertical level 33 below the vertical level 64 at which the lowermost curing tray 60 of the stack 6 is arranged. Thus, with respect to each vertical level 64 at which the individual curing trays 60 of the stack 6 are arranged one individual horizontally extending row 32 of supply holes 31 is arranged at a vertical level above the respective vertical level 64, and one individual horizontally extending row 32 of supply holes 31 is arranged at a vertical level 33 below the respective vertical level 64.

Returning to FIG. 1, the supply channel 5 extends vertically between the baffle 3 and the vertical oven wall 11 (in FIG. 1 the vertical oven wall shown on the right-hand side) and is fluidically connected to a heating channel 4 in which a heater 43 as well as fan 44 are arranged. The gas circulating in the curing oven 1 is heated by the heater 43 to a predetermined curing temperature which may, for example, be in the range of 50° C. to 120° C., more particularly in the range of 55° C. to 100° C. The fan 44 generates a circulating gas flow such that the heated gas is transported via a channel outlet 42 of the heating channel 4 arranged downstream of the heater 43 and the fan 44 to the supply channel 5 (indicated by the unlabeled arrows). The heated gas flows vertically down the supply channel 5 and from the supply channel 5 horizontally through the supply holes 31 of the baffle 3 into the curing chamber 2 above and below each of the curing trays 60 of the stack 6 towards the chamber outlet 22 of the curing chamber 2. The chamber outlet 22 is fluidically connected to a channel inlet 41 of the heating channel 4 such that the circulating gas flows back to the heating channel 4 to be re-heated to the predetermined curing temperature before it is again transported to the supply channel 5.

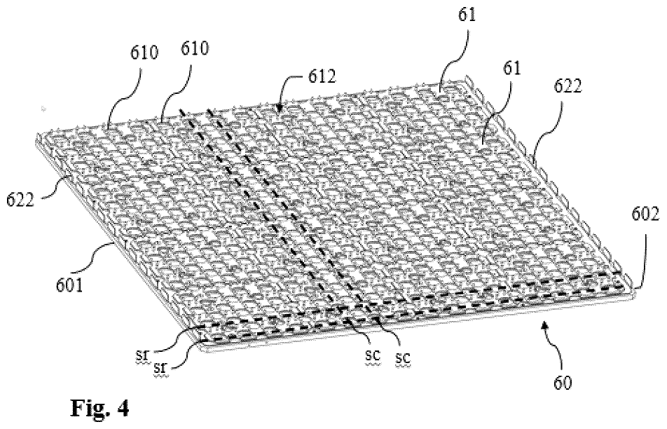

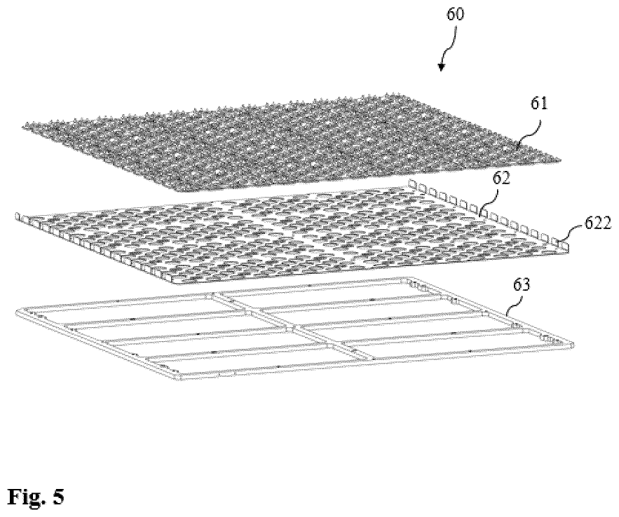

FIG. 4 shows a perspective view of an embodiment of the curing tray 60 of the stack 6, and FIG. 5 shows a perspective exploded view of the curing tray 60 shown in FIG. 4. As can be seen in FIG. 4, the curing tray 60 has a rectangular shape with a first longitudinal end 601 and a second longitudinal end 602 arranged opposite to the first longitudinal end 601. The curing tray 60 further comprises a plurality of rectangular support plates 61. Each of the support plates 61 has a rectangular shape and comprises an upper support surface 612. A plurality of mold seats 610 are arranged on the upper support surface 612 of the respective support plate 61. The mold seats 610 of all support plates 61 of the curing tray 60 are arranged in a rectangular pattern along seat rows sr and seat columns sc. The seat rows sr extend along a longitudinal direction of the support plates 61 and extend from the first longitudinal end 601 to the second longitudinal end 602 of the curing tray 60. The seat columns sc extend in a transverse direction perpendicular to the longitudinal direction.

As can be seen in the exploded view of the curing tray 60 in FIG. 5, the curing tray 60 comprises a mounting frame 63 and a tray plate 62 mounted to the mounting frame 63. The plurality of support plates 61 is mounted to the tray plate 62. Both, the tray plate 62 and the mounting frame 63 are made of aluminum.

Turning back to FIG. 4, the curing tray 60 comprises a first plurality of shielding tabs 622 arranged at the first longitudinal end 601 of the curing tray 60 as well as a second plurality of shielding tabs 622 arranged at the second longitudinal end 602 of the curing tray 60. The shielding tabs 622 are integrally formed with the tray plate 62 (see FIG. 5) and extend upwardly therefrom at both the first longitudinal end 601 and the second longitudinal end 602. The support plates 61 may be made of plastic, in particular an injection-moldable plastic, for example polybutylene terephthalate reinforced by glass fibers (e.g. by 10% glass fibers) to thermally separate the closed lens molds arranged on the upper support surface 612 of the respective support plate 61 against an unwanted heat transfer from the tray plate 62.

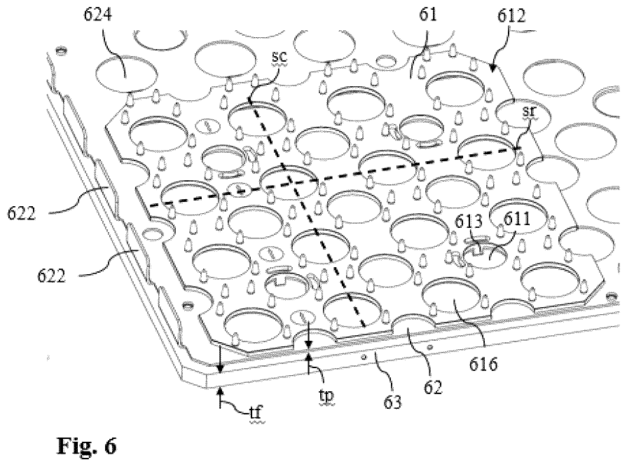

FIG. 6 shows an enlarged perspective view of a portion of the (assembled) curing tray 60. The tray plate 62 generally has a plate thickness tp of less than 1.5 millimeters, in particular less than 1.3 millimeters. For example, the tray plate 62 may have a plate thickness tp of 1 millimeter. The mounting frame 63 on which the tray plate 62 is mounted generally has a frame thickness tf of less than 9 millimeters, in particular less than 8 millimeters. For example, the mounting frame 63 may have a frame thickness tf of 7 millimeters.

The support plate 61 comprises a plurality of support plate through-openings. The support plate through-openings comprise a plurality of support plate seat through-openings 616, each of which is arranged at one of the mold seats 610, such that a bottom of the base mold half 83 of the closed lens mold 8 arranged at the respective mold seat 610 is in contact with the heated gas through the respective support plate seat through-opening to make sure each closed lens mold 8 is uniformly heated by the heated gas from all sides (and not only from the top). The tray plate 62 comprises a plurality of tray plate through-openings, and these tray plate through-openings comprise a plurality of tray plate seat through-openings 624, each of which is arranged to be aligned with one of the support plate seat through-openings 616.

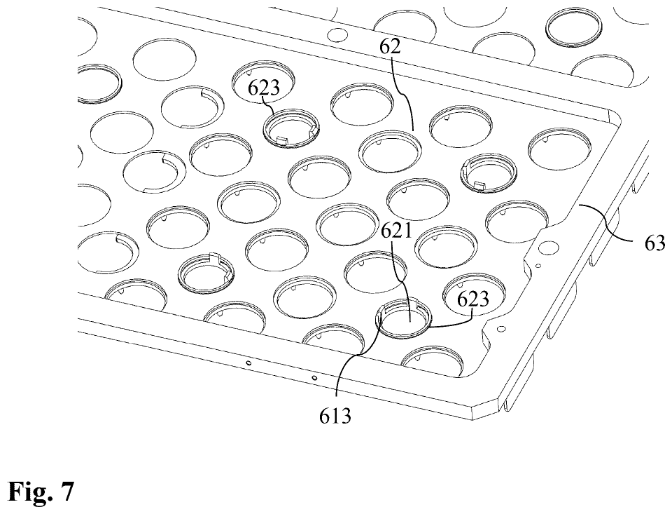

The plurality of support plate through-openings of the support plate 61 further comprises a plurality of support plate convection through-openings 611 which are arranged between the seat rows sr and the seat columns sc. The plurality of tray plate through-openings of the tray plate 62 comprises a plurality of tray plate convection through-openings 621, wherein each of the tray plate convection through-openings 621 is arranged to be aligned with one support plate convection through-opening 611 of the plurality of support plate convection through-openings to allow convection of heated gas through the curing trays 60. Two latches 613 extend from a respective edge of some of the support plate convection through-openings 611 downwardly through the tray plate through-openings 621 and engage with an edge of the respective tray plate convection through-opening 621 aligned with the respective support plate convection through-opening 611, thereby releasably attaching the support plate 61 to the tray plate 62, as can be seen in the bottom view of a portion of the curing tray 60 shown in FIG. 7.

As can be seen further in FIG. 7, the edges of some of the tray plate convection through-openings 621 of the plurality of tray plate convection through-openings 621 comprise a crimped edge 623 protruding downwardly from the bottom surface of the tray plate 62 (upwardly in FIG. 7 due to FIG. 7 showing a bottom view). The respective crimped edge 623 generally has a protrusion length that is in the in the range of 1.5 millimeters to 2.5 millimeters, in particular in the range of 1.7 millimeters to 2.3 millimeters. For example, it may have a protrusion length of 2 millimeter. The respective pair of latches 613 extending from the support plate through-openings 611 engage with the crimped edge 623 of the corresponding tray plate convection through-opening 621 of the tray plate 62, thus releasably attaching the support plates 61 to the tray plate 62.

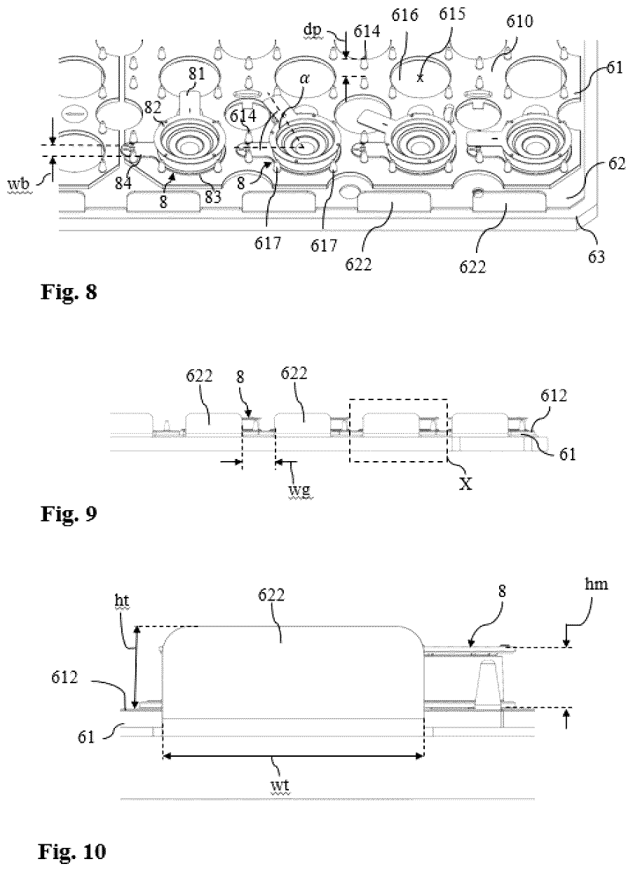

FIG. 8 shows a portion of the curing tray 60 with some closed lens mold 8 arranged at a respective mold seat 610. Each of the closed lens molds 8 comprises a top mold half 82 and a base mold half 83 arranged thereon to form the closed lens mold 8. Top mold half comprises a radially protruding top mold half tab 81 and the base mold half 83 comprises a radially protruding base mold half tab 84. In the embodiment shown, the top mold half tab 81 and the base mold half tab 84 have same length (in the radial direction of the closed lens mold 8). The top mold half tab 81 and the base mold half tab 84 may include an angle α which is equal to or less than 90 degrees (plus or minus). The angle α may be different or the same for each of the closed lens molds 8 arranged at the mold seats 610 of the same seat row sr. In case the ophthalmic lens formed in the closed lens mold 8 is a toric lens, the angle α included by the top mold half tab 81 and the base mold half tab 84 may be indicative of the orientation of the axes of the toric lens (in particular it may be indicative of the major axis, with the minor axis being perpendicular to the major axis).

The (translational) position of the closed lens mold 8 at the respective lens mold seat 610 is determined and locked a by plurality of position-locking elements 617 in the form of pins extending upwardly from the upper support surface 612 of the support plate 61, which are arranged on the upper support surface 612 of the support plate 61 such that they determine and lock the translational (x-y) position of the closed lens mold 8 at the respective mold seat 610.

In addition, each of the mold seats 610 comprises orientation-locking elements 614 which are embodied as a pair of orientation-locking pins 614 extending upwardly from the upper support surface 612 of the support plate 61. A distance dp between a pair of orientation-locking pins 614 matches the base mold half tab width wb of the base mold half tab 84. The pair of orientation-locking pins 614 is arranged such that determine and lock the base mold half tab 84 of the closed lens mold 8 with a predetermined rotational orientation at the respective mold seat 610.

The center of each mold 8 is aligned with the seat center 615 at the respective mold seat 610. The orientation-locking pins 614 of all mold seats 610 are arranged at the same positions relative to the respective seat center 615, so that the base mold half tabs 84 of the base mold halves 83 of all closed lens molds 8 arranged at the mold seats 610 of the support plates 61 extend in the same direction. Or to say it in other words, the rotational orientation of the base mold halves 82 of all closed lens molds 8 arranged at the mold seats 610 is the same.

As can be seen in the side view of a portion of the curing tray 60 shown in FIG. 9, each of the shielding tabs 622 of the curing tray 62 is arranged to partially overlap with the closed lens mold 8 arranged at the mold seats 610 of the associated seat row sr. In particular, each of the shielding tabs 622 extends in the transverse direction of the support plate 61 to hide the orientation-locking pins 614 and the seat center 615 of the respective seat row sr and thus shields the respective portions of the closed lens molds 8 arranged in the respective seat row sr from being directly exposed to the flow of heated gas. Adjacently arranged shielding tabs 622 are spaced from one another by a gap having a gap width wg. The heated gas may flow through these gaps to cause curing of the lens-forming material contained in the closed lens molds 8.

FIG. 10 shows an enlarged view of detail X of FIG. 9. As shown in FIG. 10, each of the shielding tabs 622 has a predetermined tab width wt, which is at least as large as the distance between the orientation-locking pins 614 and the seat center 615, as well as a tab height ht measured from the upper support surface 612 of the respective support plate 61. The tab height ht exceeds the mold height hm of the closed lens mold 8. The predetermined tab width wt of the shielding tabs 622 and the predetermined gap width wg between adjacently arranged shielding tabs 622 are determined such that each of the shielding tabs 622 shields a substantial portion of the closed lens molds 8 arranged at the mold seats 610 of the associated seat row sr, this substantial portion being in the range of 50% to 70%, in particular 55% to 65%, of the closed lens molds 8. In particular, the base mold half tabs 84 and the top mold half tabs 81 of the closed lens molds are more or less completely shielded in order to avoid that the gas flow entering through the gap between adjacently arranged shielding tabs 622 may inadvertently lift a closed lens mold 8 off of a mold seat 610 of the associated seat row sr.

Embodiments of the apparatus according to the present invention have been described with the aid of the drawings. However, the invention is not limited to these embodiments. Rather, various changes and modifications can be made without departing from the teaching underlying the instant invention. The scope of protection is therefore defined by the appended claims.

1. Apparatus for thermally curing a lens-forming material contained in a plurality of closed lens molds to form a plurality of ophthalmic lenses, in particular contact lenses such as soft contact lenses,
the apparatus comprising:
a curing oven (1) comprising
a curing chamber (2) having a chamber inlet (21) and a chamber outlet (22) arranged opposite to the chamber inlet (21), for accommodating a stack (6) of curing trays (60) for carrying the plurality of closed lens molds (8) with the lens-forming material contained therein at a predetermined position between the chamber inlet (21) and the chamber outlet (22), with each curing tray (60) of the stack (6) arranged at a respective predetermined vertical level;
a supply channel (5) for supplying gas heated to a predetermined curing temperature to the curing chamber (2); and
a baffle (3) arranged at the chamber inlet (21) and separating the supply channel (5) from the curing chamber (2), the baffle (3) comprising a plurality of supply holes (31), wherein at the chamber inlet (21) the curing chamber (2) is fluidly connected with the supply channel (5) via the supply holes (31) only,
wherein the plurality of supply holes (31) of the baffle (3) are arranged along a plurality of horizontally extending rows (32), with one said row (32) of the plurality of rows (32) being arranged at an intermediate vertical level (33) between each adjacent ones of the said predetermined vertical levels (64) at which the curing trays (60) of the stack (6) are to be arranged,
and wherein further one said row (32) of the plurality of rows (32) is arranged at a vertical level above the predetermined vertical level of the uppermost curing tray of the stack (6) and one said row (32) of the plurality of rows (32) is arranged at a vertical level below the predetermined vertical level of the lowermost curing tray of the stack (6).

2. Apparatus according to claim 1, wherein the supply holes (31) of the baffle (3) are arranged along each individual row of the plurality of horizontally extending rows (32) in a zigzag pattern.

3. Apparatus according to claim 1, wherein a total cross-sectional area of all supply holes (31) of the baffle (3) is equal to or larger than a minimum cross-sectional area of the supply channel (5).

4. Apparatus according to claim 1, wherein the baffle (3) comprises a flat metal sheet, in particular a flat aluminum sheet, comprising the plurality of supply holes (31).

5. Apparatus according to claim 1, wherein each of the supply holes (31) of the baffle (3) has a circular cross-section having a diameter in the range of 6 millimeters to 10 millimeters, in particular in the range of 7 millimeters to 9 millimeters, especially 8 millimeters.

6. Apparatus according to claim 1, wherein the curing oven (1) further comprises
a heater (43) for heating a gas to the predetermined curing temperature, the heater being arranged in a heating channel (4), the heating channel (4) comprising
a channel inlet (41) which is fluidly connected to the chamber outlet (22) of the curing chamber (2);
a channel outlet (42) which is fluidly connected to the supply channel (5); and
a fan (44) for generating a circulating gas flow inside the curing oven (1).

7. Apparatus according to claim 1, further comprising a said stack (6) of curing trays (60) for carrying the plurality of closed lens molds (8) with the lens-forming material contained therein.

8. Apparatus according to claim 7, wherein each curing tray (60) of the stack (6) comprises at least one support plate (61), the at least one support plate (61) comprising an upper support surface (612) with a plurality of mold seats (610) arranged thereon in a rectangular pattern along seat rows (sr) and seat columns (sc), each mold seat (610) configured to receive one of the closed lens molds (8),
wherein the seat rows (sr) extend along a longitudinal direction of the at least one support plate (61), and wherein the seat columns (sc) extend along a transverse direction of the at least one support plate (61) perpendicular to the longitudinal direction,
wherein further each curing tray (60) of the stack (6) comprises a first plurality of shielding tabs (622) arranged at a first longitudinal end (601) of the respective curing tray (60), each of the shielding tabs of the first plurality of shielding tabs (622) having a predetermined height (ht) above the upper support surface (612) of the support plate (61) and having a predetermined tab width (wt) in the transverse direction of the support plate (61),
and wherein each shielding tab (622) of the first plurality of shielding tabs (622) at least partially overlaps with the mold seats (610) of one said seat row (sr) in the transverse direction of the support plate (61) to shield the closed lens molds (8) arranged at the mold seats (610) of the respective seat row (sr) from being exposed to a flow of heated gas supplied to the curing chamber of the curing oven through the supply holes of the baffle, with adjacently arranged shielding tabs (622) being separated from one another by a gap of a predetermined gap width (wg).

9. Apparatus according to claim 8,
wherein each of the closed lens molds (8) comprises a base mold half (83) and a top mold half (82) arranged on the base mold half (83),
the base mold half (83) comprising a radially protruding base mold half tab (84) and the top mold half (82) comprising a radially protruding top mold half tab (81),
with the top mold half tab (81) and the base mold half tab (84) including a rotational angle (α) between them which is equal to or less than 90 degrees;
wherein further each mold seat (610) of the plurality of mold seats (610) arranged on the upper support surface (612) of the support plate (61) comprises a seat center (615) as well as orientation-locking elements (614) for locking the respective base mold half tab (84) therebetween such that the base mold half tabs (84) of all base mold halves extend in a same predetermined direction that corresponds to the transverse direction of the at least one support plate (61);
and wherein each of the shielding tabs (622) of the first plurality of shielding tabs is arranged to extend at least from the orientation locking elements (614) to the seat centers (615) of the mold seats of the respective seat row (sr).

10. Apparatus according to claim 8,
wherein each curing tray (60) of the stack (6) comprises a second plurality of shielding tabs (622) arranged at a second longitudinal end (602) of the respective curing tray (60) opposite to the first longitudinal end (601),
wherein the number of the second plurality of shielding tabs (622) corresponds to the number of the first plurality of shielding tabs (622),
and wherein each of the shielding tabs (622) of the second plurality of shielding tabs is aligned with a respective shielding tab (622) of the first plurality of shielding tabs (622).

11. Apparatus according to claim 8,
wherein each curing tray (60) of the stack (6) further comprises
a mounting frame (63); and
a tray plate (62) mounted to the mounting frame (63);
wherein the at least one support plate (61) is mounted to the tray plate (62).

12. Apparatus according to claim 11, wherein the plurality of shielding tabs (622) are integrally formed with the respective tray plate (62) and extend upwardly therefrom.

13. Apparatus according to claim 11,
wherein the mounting frame (63) is made of aluminum and has a thickness (tf) of less than 9 millimeters, in particular less than 8 millimeters, and especially 7 millimeters.

14. Apparatus according to claim 11,
wherein the tray plate (62) is made of aluminum and has a thickness (tp) of less than 1.5 millimeters, in particular less than 1.3 millimeters, especially 1 millimeter.

15. Apparatus according to claim 14,
wherein the at least one support plate (61) comprises a plurality of support plate through-openings (611), and wherein the tray plate (62) comprises a plurality of tray plate through-openings (621) which are aligned with the plurality of support plate through openings (611), wherein the support plate (61) comprises a latch (613) extending downwardly from an edge of at least one of the support plate through-openings (611) to engage with an edge of at least one of the tray plate through-openings (621) to attach the at least one support plate (61) to the tray plate (62), wherein the edge of the at least one of the tray plate through-openings (621) to be engaged by a latch (613) comprises a crimped edge (623).
